(19) United States
(12) Patent Application Publication
(10) Pub. No.: US 2022/0279979 A1
(43) Pub. Date: Sep. 8, 2022

(54) APPARATUS FOR HEATING AND FOAMING A LIQUID, IN PARTICULAR A BEVERAGE

(71) Applicant: EVERSYS HOLDING SA, Sierre (CH)

(72) Inventors: Grégoire LOCHER, Daillon (CH); Sébastien ROBYR, Sierre (CH)

(21) Appl. No.: 17/632,499

(22) PCT Filed: Jun. 8, 2020
(86) PCT No.: PCT/EP2020/065822

§ 371 Date: Feb. 2, 2022

(30) Foreign Application Priority Data
Aug. 7, 2019 (DE) 20 2019 104 349.0

(51) Int. Cl. A47J 43/12; A47J 31/44; A23P 30/40; B01F 23/20; B01F 35/71; B01F 23/235; G05D 7/06

(52) U.S. Cl. CPC A47J 43/126; A47J 31/4489; A47J 43/128; A23P 30/40; B01F 23/291; B01F 35/71745; B01F 35/7179; B01F 23/235; G05D 7/0635; B01F 2101/07

(57) ABSTRACT

The invention relates to an apparatus for heating and foaming a liquid, in particular a beverage, comprising a steam line (6), which can be connected to a steam generator (1); a pressurized gas line (4), which can be connected to a pressurized gas source (2); and a conveying means (3), connected to the steam line (6) and the pressurized gas line (4), for generating and transferring a steam/gas mixture into the liquid, and a controllable switching valve (5), wherein hot steam is supplied to the conveying means (3) via the steam line (6) and a pressurized gas flow under a defined constant pressure is supplied via the pressurized gas line (4) and pressure pulses (p) are generated from the pressurized gas flow by means of the switching valve (5). In order to damp the generated pressure pulses, the conveying means (3) comprises an expansion chamber (15) having a nozzle (14) arranged on the downstream end of the expansion chamber (15).

### CROSS-REFERENCE TO RELATED APPLICATIONS

This patent application is a national phase filing under section 371 of PCT/EP2020/065822, filed on Jun. 8, 2020, which claims the priority of German patent application 202019104349.0, filed on Aug. 7, 2019 and Australian patent application 2019901944 filed on Jun. 5, 2019, each of which is hereby incorporated by reference in its entirety.

### TECHNICAL FIELD

The invention relates to an apparatus for heating and frothing a liquid, in particular a beverage, according to the preamble of claim 1. The apparatus can be used in particular for heating and frothing milk, for example for the production of milk-containing hot beverages, such as cappuccino, latte macchiato, or cocoa beverages.

### BACKGROUND

An apparatus for heating and frothing a beverage product, in particular milk, is known from DE 10 2011 077 776 A1. This apparatus comprises a steam generator, a source of compressed air with an air supply line for supplying compressed air from the source of compressed air to the steam generator and a steam/air line connected to the steam generator for supplying a steam/air mixture from the steam generator to the beverage product. A shut-off element, for example in the form of a valve, is provided on the air supply line and/or the steam/air line, respectively. The apparatus enables improved foaming of the beverage product by leading the compressed air directly from the compressed air source into the steam generator. This provides a heated steam/air mixture already in the steam generator, which can reduce condensation of liquid in the steam line. By opening and closing the shut-off elements in the air supply line or the steam/air line, the air flow or the flow of the steam/air mixture into the beverage product can be controlled and regulated.

Another apparatus for heating and frothing milk, in particular for preparing cappuccino in a coffee machine, is described in EP 1 501 398 A1. This apparatus comprises a steam-generating hot water heater, a conveyor with an open end which can be immersed in a vessel containing milk, a steam line for supplying steam which is connected between the hot water heater and the conveyor, a shut-off element, a compressed air source, a compressed air line connected between the compressed air source and the conveyor for supplying compressed air into the conveyor, a temperature sensor, connected to the milk submersible end of the conveying means to sense the temperature of the milk in the vessel, and a control unit coupled to the shut-off element, the compressed air source and the temperature sensor and programmed to control opening and closing of the shut-off element and actuation of the compressed air source independently of each other and according to the desired temperature and/or frothing of the milk. This allows the milk to be heated to a required temperature and frothed at a predetermined froth/liquid ratio. The froth/liquid ratio of the frothed milk can thus be adjusted to a certain extent according to the needs.

The known apparatus for heating and foaming beverages, especially dairy beverages, allow automatic heating and foaming of the beverage while maintaining a predefined beverage temperature. However, the specification or generation of a desired consistency of the foamed beverage and, in particular, a predetermined foam/liquid ratio of the generated foam is only possible to a limited extent. To produce a desired consistency with a predetermined ratio of the foam to the liquid of the foamed beverage, predetermined control programs are programmed into the control unit of the known apparatus so that an operator can specify a desired foam temperature and consistency by selecting one of the control programs, whereupon automated control of the apparatus takes place according to the selected control program. On the one hand, this ensures a fully automated process. On the other hand, an operator can no longer intervene in the process, which becomes necessary, for example, if it becomes apparent during foaming that the desired foam consistency cannot be achieved. Furthermore, the operator is bound to the pre-programmed control programs and cannot create an individual composition of the foamed liquid with regard to its temperature and foam consistency as well as other properties of the foam.

However, it is known that the foam-forming properties of milk depend not only on the foaming temperature but also to a large extent on the properties of the milk used, such as fat content, pasteurization or thermal pre-treatment (short-term, high-temperature or ultra-high-temperature heating), pH value, protein content and storage time, as described, for example, in the dissertation by Katja Borcherding, University of Kiel, “Untersuchungen zur Charakterisierung der Makro- and Mikrostruktur von Milchschäumen” (November 2004). There is therefore a need to improve the known apparatus for heating and foaming milk so that liquid foams and in particular milk foams with an individually desired and different consistency and stability can be produced.

One possibility to influence the consistency and stability of foamed milk in a controlled manner is to introduce pressure pulses with variable frequency, pulse duration and amplitude together with a steam flow into the milk to be foamed. From EP 1 776 905 B1 and DE 10 2015 117 650 A1, apparatus for heating and frothing milk or milk beverages are known in which compressed air pulses are introduced into the milk or milk beverage together with a steam flow. By adjusting the frequency, amplitude and/or pulse duration of the compressed air pulses, the consistency of the milk foam produced can be adjusted, as disclosed in DE 10 2015 117 650 A1.

It has been shown, however, that the introduction of sharp pulses of compressed air into the milk or milk beverage can cause pulsating frothing of the milk in the container intended to hold the milk or milk beverage and, as a result, liquid can spray out of the container when the milk is frothing in a vessel, e.g. a cup or a pitcher. When simultaneously heating and frothing milk in a mixing or heating unit to which cold milk and a mixture of hot steam with pressure pulses of a pressurized gas are supplied, the sharp pressure pulses cause inhomogeneous mixing of the liquid with the steam/pressurized gas mixture.

On this basis, the invention is based on the task of demonstrating a apparatus and a method for heating and foaming a liquid, with which, on the one hand, the operator has a high degree of flexibility with regard to a controlled setting of the properties of the foam formed, such as, for example, its consistency, creaminess, porosity, foam density and foam stability (discharge) and, on the other hand, the spraying of liquid out of the receiving container during foaming is prevented. Furthermore, during simultaneous heating and foaming of a liquid with a steam/compressed gas mixture in a mixing or heating unit, the most homogeneous possible mixing of the liquid with the steam/compressed gas mixture should be ensured. The properties of the foam formed should also be adjustable as accurately, consistently and repeatedly as possible.

These tasks are solved with an apparatus having the features of claim 1 and with a method having the features of claim 36. Preferred embodiments of the apparatus and the method can be found in the dependent claims.

The apparatus according to the invention for heating and foaming a liquid comprises a steam line, a pressurized gas line and a conveying means connected to the steam line and the pressurized gas line for generating and transferring a steam/gas mixture into the liquid. For transferring the steam, which is provided by a steam generator connected to the steam line, into the conveying means, the conveying means is connectable to the steam generator via the steam line. Accordingly, the conveying means can be connected to a compressed gas source via the compressed gas line in order to supply the conveying means with a compressed gas flow which is provided by the compressed gas source. The apparatus contains a controllable switching valve which generates pressure pulses from the pressurized gas flow under a predetermined constant pressure in the pressurized gas line and directs them into an expansion chamber of the conveying means with a nozzle located at the downstream end of the expansion chamber.

For this purpose, the switching valve is preferably opened and closed periodically with an adjustable frequency, whereby pressure pulses of compressed gas, e.g. compressed air, are generated by the switching valve. In the expansion chamber of the conveying means, the pressure pulses of compressed gas that are introduced can expand and are ejected through the downstream nozzle. The expansion chamber has a (significantly) larger diameter (or flow cross-section) than the compressed gas line and the nozzle.

The expansion chamber and the nozzle act together as a snubber and dampen the pressure curve of the pressure pulses introduced into the expansion chamber. The snubber, which consists of the expansion chamber and the nozzle, has a damping effect on the pressure pulses, as in a pneumatic pulsation damper or analogous to an RC damping element in an electrical circuit, whereby the expansion chamber acts analogous to an electrical capacitor and the nozzle analogous to an electrical resistor. This results in a damped temporal pressure curve p(t) of the steam/gas mixture flowing out of the expansion chamber through the nozzle with damped, periodically repeating pressure peaks p0. By damping the pressure peaks, an unintentional spraying of liquid out of the container holding the liquid can be avoided.

The pressure stream flowing out of the expansion chamber through the nozzle preferably has a temporal pressure curve p(t) with periodically repeating and plateau-shaped flattened pressure peaks (p0), whereby each pressure peak (p0) has an exponentially decreasing pressure curve up to the temporally following pressure peak. The temporal decrease of the pressure curve of a pressure peak, i.e. the degree of damping, is determined by the dimensioning of the expansion chamber and the nozzle, in particular by the volume of the expansion chamber and the flow cross-section of the nozzle, and can be described by the relation p(t)=p0·e^{-t/τ}, whereby the time constant t depends on the volume of the expansion chamber and the flow cross-section of the nozzle. The height of the (plateau-shaped flattened) pressure peaks (p0) depends on the constant pressure of the compressed gas supplied by the compressed gas source. It is expedient to provide an adjustable pressure reducer upstream of the switching valve in the delivery medium or that of the compressed gas line, with which the pressure of the compressed gas flow supplied to the switching valve can be adjusted and kept constant.

The pressurized gas stream flowing from the expansion chamber through the nozzle has a temporal pressure curve p(t) with a constant pressure offset (p1). The temporal pressure curve p(t) of the pressurized gas flow is therefore composed of the constant pressure offset p1 and the damped pressure peaks p0: p(t)=p1+p0.

The parameters of the pressure pulses generated by periodically opening and closing the switching valve, such as pulse duration and repetition rate (pulse frequency), can be conveniently changed and set by an operator at the apparatus, for example by means of switching or rotary knobs. The switching valve can be designed as a solenoid valve with pulse width modulation in order to enable fast and precise control. The switching valve can be opened and closed periodically with a predetermined duration (pulse length or pulse duration) and repetition rate (pulse frequency). It is also possible to specify different opening and closing times for the switching valve. The preset opening or closing times for the switching valve define the pulse duration of the pressure pulses. The amplitude of the generated pressure pulses results from the (predefined and expediently adjustable via the pressure reducer) pressure that is permanently present in the compressed gas line.

The switching valve is arranged in the delivery medium upstream of the expansion chamber. The compressed gas flow provided by a reciprocating compressor is introduced into the expansion chamber via the compressed gas line through the switching valve arranged in the delivery means. The switching valve is opened and closed periodically to generate pressure pulses.

To generate a steam/gas mixture, the conveying means conveying means in a preferred embodiment of the invention contains an annular channel which is arranged coaxially to the preferably hollow-cylindrical expansion chamber and is connected to the steam line. The annular channel is connected to the steam line at an upstream end and to a mixing channel at a downstream end, and the nozzle opens centrally into the mixing channel. This arrangement allows efficient and uniform mixing of the compressed gas flow and the steam flow.

A compact design of the conveyor means can be ensured if the expansion chamber, the ring channel and the mixing channel are arranged in a reactor block made of plastic. The production of the reactor block from plastic ensures good thermal insulation and enables manual handling of the conveyor without the risk of the user getting burned during the foaming process. Furthermore, the controllable switching valve can also be integrated in the conveying means. This also allows for a compact design. However, the controllable switching valve can also be arranged in the compressed gas line and separated from the conveying means.

The expansion chamber and the nozzle are preferably made of a material with good thermal conductivity, especially stainless steel. This ensures good thermal conductivity of the expansion chamber and enables the removal of condensation that has settled in the expansion chamber. The expansion chamber is expediently hollow-cylindrical or tubular and runs in the axial direction in the reactor block.

For the transfer of the steam/gas mixture generated in the mixing channel into the liquid to be foamed, the downstream end of the mixing channel is preferably connected to a discharge line.

In a useful embodiment of the invention, the discharge line is designed as an immersion tube and has an open end that can be immersed in the liquid, the liquid being in a vessel, for example a cup. The discharge line is advantageously designed as a flexible tube, which facilitates immersion in the liquid.

The steam/gas mixture generated in the delivery medium is thereby fed into the liquid via the discharge line, whereby the liquid is heated and foamed. The consistency of the foam produced in this process, in particular the ratio of foam to liquid, as well as other parameters of the foam such as its creaminess, porosity, foam density and foam stability (drainage), are thereby dependent on the selected parameters of the pressure pulses of the compressed gas and can therefore be influenced by selecting suitable parameters of the pressure pulses. An operator can therefore influence the properties of the foam by changing the parameters of the pressure pulses before and even during the foaming process. For example, the repetition rate (pulse frequency) of the pressure pulses periodically introduced into the expansion chamber can be changed even during the foaming process. By changing the pulse frequency of the pressure pulses, the consistency of the foam produced in the liquid is influenced in particular. In this way, it is possible, for example, to select the consistency of the foam produced within predetermined limits between fine and coarse by continuously adjusting the pulse frequency between a minimum value and a maximum value via a rotary control provided on the apparatus. In this way, the apparatus according to the invention makes it possible to produce a foam of any consistency, whereby the foam consistency produced can also be adjusted (to a certain extent) during the foaming process.

The repetition rate (pulse frequency) of the pressure pulses generated periodically by the switching valve is expediently in the range of 0.1 to 200 Hz and preferably between 1 and 50 Hz. In addition to the pulse frequency, the pulse duration and/or the amplitude of the pressure pulses is preferably also adjustable. For setting a desired pulse frequency, pulse duration and pulse amplitude, the apparatus expediently has a suitable input device with push-button switches or rotary controllers, via which the desired parameters of the pressure pulses can be entered by an operator and set accordingly by the control device. In particular for setting the pulse frequency, a rotary control is expediently provided, which is preferably continuously adjustable between a minimum position and a maximum position, in order to be able to set the repetition rate (pulse frequency) of the pressure pulses between a minimum value and a maximum value (continuously). An operator can use this control dial, for example, to select a desired consistency for the foam at the beginning of the foaming process and set it via the control dial. The setting made can be changed during the foaming process and, in particular, readjusted in order to produce a foam quality and consistency adapted to individual requirements.

In order to maintain a desired temperature of the liquid during foaming, the apparatus expediently comprises a temperature sensor for detecting the temperature of the liquid or the generated liquid foam. The temperature sensor is coupled to the control device. Furthermore, a steam valve is expediently provided in the steam line, which is also coupled to the control device and can be opened and closed by the latter. As soon as the temperature sensor detects a product temperature (temperature of the liquid or liquid foam) specified by the operator, the steam valve in the steam line is closed and the introduction of the pressure pulses into the expansion chamber is stopped at the same time. For this purpose, the switching valve is closed and/or the compressor of the pressurized gas source is switched off.

In order to prevent steam or liquid from entering the pressurized gas source, a non-return valve is expediently arranged in the conveying means conveying means between the switching valve and the expansion chamber, which only allows pressurized gas (pressure pulses) to pass through into the expansion chamber, but prevents pressurized gas and/or steam from flowing through in the opposite direction.

In order to optimize and adjust the pressure curve over time of the compressed gas flow directed from the expansion chamber through the nozzle into the mixing channel, it is useful if the flow cross-section of the nozzle can be adjusted. For this purpose, the nozzle can be designed, for example, as a throttle valve with an adjustable flow cross-section. This provides an additional degree of freedom for influencing the properties of the foamed liquid.

The apparatus according to the invention has the advantage that an exact, controllable and repeatable adjustment of the pressure curve over time of the compressed gas and of the steam-gas mixture produced in the mixing channel by mixing with the steam is made possible via the switching valve. The switching valve can be used to precisely adjust the quantity as well as the pressure and its temporal course of the compressed gas (in particular compressed air) introduced into the mixing channel of the conveying means. The expansion chamber arranged upstream of the mixing channel serves to (exponentially) dampen and smooth the pressure curve over time of the compressed gas flow introduced into the mixing channel. The pressure curve of the compressed gas flow over time has a constant pressure offset P1, which has the advantage that there is always an overpressure at the inlet of the mixing channel into which the nozzle opens and no underpressure can develop. This ensures that the pressure of the pressurized gas stream flowing from the nozzle into the mixing channel is always higher than the pressure of the steam stream also flowing into the mixing channel and that the pressurized gas stream can therefore flow into the mixing channel against the pressure of the steam stream from the nozzle and mix with the steam stream there. The pressure of the pressurized gas flow directly in front of the nozzle can be precisely controlled (with a constant, predefined flow cross-section of the nozzle and predefined amplitude of the pressure surges generated by the switching valve) via the frequency of the pressure surges generated by the switching valve and adjusted in such a way that the pressure of the pressurized gas flow flowing out of the nozzle into the mixing channel is at all times higher than the pressure of the steam flow flowing into the mixing channel.

The apparatus according to the invention can be used to foam different liquids that can be foamed, such as cow's milk, coconut milk, soy milk, almond milk or milk-containing beverages such as cocoa milk, latte, iced coffee, etc., whereby the composition, porosity and consistency of the milk foam produced can be precisely and reproducibly adjusted and adapted to the properties of the liquid used to produce foam. In particular, a shiny, dense milk foam can be produced, as required for the production of creative designs of the milk foam surface of espresso beverages with graphic motifs (so-called “latte art”).

In a further embodiment of the invention, the discharge line of the conveying means is connected to a first input of a mixing device, to which the liquid is supplied via a second input. The liquid is in a container which is connected to the second input of the mixing device via a liquid line, so that the liquid can be supplied to the mixing device. In the mixing device, the liquid is mixed with the pressure pulses of the steam/compressed gas mixture, which are fed to the mixing device from the conveying means via the discharge line. This causes the liquid in the mixing device to be hot foamed. The damped pressure pulses of the steam/compressed gas mixture ensure homogeneous mixing of the liquid and the steam/compressed gas mixture.

In this embodiment, the container is preferably connected to the compressed gas line via a branch line. Via said branch line, the pressurized gas (e.g. compressed air) provided by the pressurized gas line can be fed into the container in which the liquid is stored. When a pressurized gas is introduced into the container through the branch line, an overpressure is created in the container, which conveys the liquid in the container through the liquid line into the mixing device. In this embodiment of the apparatus according to the invention, the liquid is thus conveyed into the mixing device by the pressurized gas, which is provided by a source of pressurized gas and introduced into the pressurized gas line. For this purpose, the compressed gas line is connected to a compressed gas source during operation of the apparatus, which generates a pressurized gas (compressed gas, in particular compressed air).

As a result, the apparatus according to the invention can dispense with a pump for conveying the liquid into the mixing device, which makes the manufacture of the apparatus more cost-effective and the apparatus less susceptible to faults and less maintenance-intensive during operation.

In a practical embodiment of this embodiment, the mixing device comprises a first input and a second input as well as an output, whereby the compressed gas line and the steam line are connected to the first input and the liquid line is connected to the second input. A discharge line is expediently connected to the outlet, via which the foamed and/or heated liquid can be discharged and transferred, for example, into a cup or another collecting container.

The mixing device preferably comprises a linear channel which is oriented vertically in the mixing device. The first inlet of the mixing device, which is connected via the discharge line to the conveying means for generating and transferring the steam/compressed gas mixture, preferably opens into the linear channel at the lower end, so that the pressure pulses of the steam/compressed gas mixture generated by the conveying means flow upwards in the mixing device in the linear channel against the force of gravity. This enables homogeneous mixing of the liquid with the steam/compressed gas mixture.

In the area of the second inlet of the mixing device, which is connected via the liquid line to the container and the liquid contained therein, a nozzle is expediently arranged with which the liquid supplied through the liquid line is sprayed into the mixing device. Spraying the liquid into the mixing device also contributes to a good and homogeneous mixing of the liquid with the steam/compressed gas mixture.

In this embodiment, an adjustable pressure reducer, for example in the form of an adjustable pressure relief valve, is expediently arranged in or on the compressed gas line. The adjustable pressure reducer can be used to set the pressure of the compressed gas in the compressed gas line to a desired and constant (maximum) value. The compressed gas source connected to the compressed gas line can thereby be operated in such a way that it permanently produces a compressed gas with a constant pressure.

### BRIEF DESCRIPTION OF THE DRAWINGS

These and other features and advantages of the invention will be apparent from the examples of embodiments described in more detail below with reference to the accompanying drawings. The drawings show:

FIG. 1 is a schematic representation of a first embodiment of an apparatus according to the invention with a conveying means for generating and transferring a steam/gas mixture into a liquid to be foamed, wherein the liquid is located in an open vessel;

FIG. 2 is a detailed representation of the conveying means of the apparatus of FIG. 1 in a sectional drawing,

FIG. 3 is a Pressure-Time curve of the pressurized gas flow generated in the conveying means for producing the steam/gas mixture;

FIG. 4 is a schematic representation of a second embodiment of an apparatus according to the invention with a conveying means for generating and transferring a steam/gas mixture into a mixing device to which the liquid to be foamed is fed.

### DETAILED DESCRIPTION OF ILLUSTRATIVE EMBODIMENTS

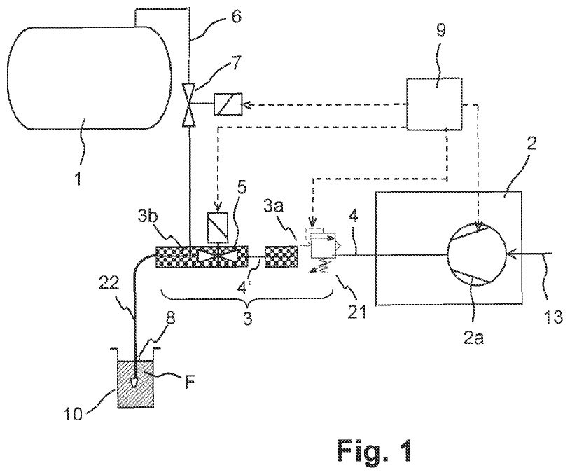

The schematic embodiment of an apparatus according to the invention shown in FIG. 1 comprises a steam generator 1, a steam line 6 extending from the steam generator 1, a compressed gas source 2 with a compressor 2a, a compressed gas line 4 extending from the compressed gas source and a conveying means 3 for transferring a steam/gas mixture into a liquid 11 to be foamed. The liquid 11, which is located here in an open-topped vessel 10 (e.g. in a pitcher), can in particular be a beverage such as milk or a milk-containing beverage. At the downstream end, the conveying means contains a discharge line 22, for example in the form of an immersion tube or a flexible hose, the open end of which can be immersed in the liquid for foaming. Steam generated in the steam generator 1 is fed to the conveying means 3 via the steam line 6 and a gas compressed in the compressed gas source 2 is introduced into the conveying means 3 via the compressed gas line 4. The gas is expediently air, but it can also be other gases such as carbon dioxide (CO₂) or nitrogen (N₂) or gas mixtures. Preferably, the compressor 2a draws in air from the environment via a gas supply line 13.

In the conveying means 3, the gas flow of the compressed gas is mixed with the steam flow to produce a steam/gas mixture, which is introduced into the liquid F via the discharge line 22.

A temperature sensor 8 is attached to the open end of the discharge line 22 immersed in the liquid, which detects the temperature of the liquid F and transmits it to a control device 9 via a measuring line. An electrically controllable steam valve 7, which can be designed as a solenoid valve, for example, is arranged in the steam line 6 between the steam generator 1 and the conveying means 3. The steam valve 7 and the compressor 2a of the compressed gas source 2 are controlled by the electronic control device 9, to which they are connected via corresponding control lines. The control device 9 contains a man-machine interface in the form of buttons, rotary knobs and a screen, which may also be touch-sensitive, for communication with a user. The user can enter control instructions and read out displayed operating states and error messages via the interface.

The conveying means 3 contains a first part 3a and a second part 3b, which are connected to each other via a compressed gas line 4′. A pressure reducer 21 is provided in the first part 3a of the conveying means 3. The pressure reducer 21 may in particular be a pressure relief valve which can be adjusted manually or via the control device 9. A switching valve 5 is arranged in the second part 3b of the conveying means 3, which can be controlled to open and close via the control device 9. The switching valve 5 can in particular be a solenoid valve which can be actuated in a pulse-width modulated manner by the control device 9.

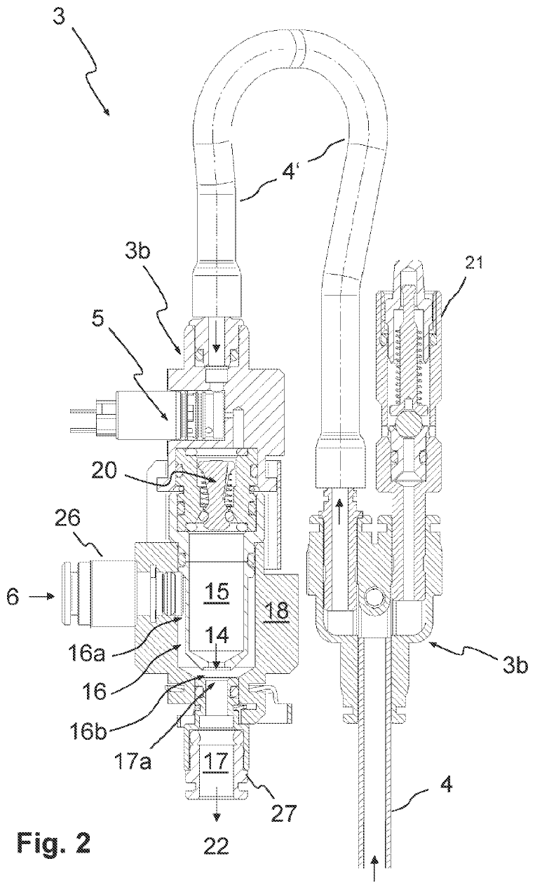

The conveying means 3 is shown in detail in a sectional drawing in FIG. 2. As can be seen in FIG. 2, the first part 3a of the conveying means 3 contains the adjustable pressure reducer 21. The pressure of the compressed gas flow provided by the compressed gas source 2 and supplied via the compressed gas line 4 can be set to a presettable value of, for example, 2 bar via the pressure reducer 21 and is maintained constant by the pressure reducer 21. In this way, pressure fluctuations of the compressor 2a of the compressed gas source 2 can be compensated. The pressurized gas flow brought to a constant pressure in the first part 3a of the conveying means 3 is conducted via the pressurized gas line 4′ into the second part 3b of the conveying means 3. The switching valve 5 is arranged at the upstream inlet of the second part 3b of the conveying means 3, through which the compressed gas flow is passed. The switching valve is periodically opened and closed by the control device, whereby both the frequency and the duration of opening and closing are controlled by the control device, according to the control instructions set by the user via the interface.

The conveying means comprises a hollow-cylindrical expansion chamber 15 arranged downstream of the switching valve 5 with a nozzle 14 arranged at the downstream end of the expansion chamber 15. The nozzle opens centrally into a downstream mixing channel 17. A non-return valve 20 is arranged between the switching valve 5 and the expansion chamber 15. The expansion chamber 15 has a (considerably) larger diameter than the compressed gas lines 4 and 4′ and the nozzle 14.

Furthermore, the conveying means 3 contains an annular channel 16 coaxially surrounding the expansion chamber 15, which at its upstream end 16a is in connection with the steam line 6 arranged on a flange 26. At its downstream end 16b, the annular channel 16 opens into the mixing channel 17. At the downstream end of the mixing channel 17, the discharge line 22 is arranged via a flange 27.

Preferably, the expansion chamber 15 and the nozzle 14 are made of a material with good thermal conductivity, in particular stainless steel, and are arranged in a thermally insulating reactor block 18. The reactor block 18 is made, for example, of a high-temperature-resistant plastic, such as PEEK. The annular channel 16 and the mixing chamber 17 are formed in the reactor block 18.

For the operation of the apparatus according to the invention, after the steam generator 1 has been put into operation, the steam valve 7 is set to the open position by the control apparatus 9 and the compressed gas source 2 is activated at the same time. The compressed gas flow generated by compressed gas source 2 passes through compressed gas line 4 into the first part 3a of the conveying means, where a constant pressure is set via pressure reducer 21. The compressed gas flow kept at constant pressure is passed via the compressed gas line 4′ through the switching valve 5 of the second part 3a of the conveying means 3. The switching valve 5 is periodically opened and closed by the control device 9 with an adjustable frequency, whereby pressure pulses are generated from the permanent pressurized gas flow and conducted through the non-return valve 20 (open in this direction) into the expansion chamber 15. In the expansion chamber, the introduced pressure pulses can expand and are ejected through the downstream nozzle 14 into the mixing channel 17.

The steam flow generated by the steam generator 1 simultaneously passes through the steam line 6 into the annular channel 16 in the second part 3b of the conveyor means. At the downstream end 16b of the ring channel 16, the steam flows into the mixing channel 17 and mixes there with the compressed gas flow that enters the mixing channel 17 through the nozzle 14. The steam/gas mixture thus formed in the mixing channel 17 finally flows through the discharge pipe 22 into the liquid for heating and foaming it (FIG. 1).

The measuring signal of the temperature sensor 8 serves as a criterion for the termination of the foaming process. The liquid heats up due to the supply of steam. Therefore, when a predetermined temperature threshold is reached, the frothing process is terminated. In the case of milk as liquid F, this is appropriate because no further frothing takes place above a certain temperature due to coagulation of the milk proteins. In this case, both the switching valve 5 and the steam valve 7 are closed simultaneously by the control device 9 as soon as the temperature sensor 8 detects the predetermined temperature threshold.

The expansion chamber 15 and the nozzle 14 act as a damping element (“snubber”) which exerts a damping effect on the pressure pulses generated by the switching valve 5. This results in a damped temporal pressure curve p(t) of the pressurized gas flow flowing through the nozzle 14 from the expansion chamber 15 with damped, periodically repeating pressure peaks p0.

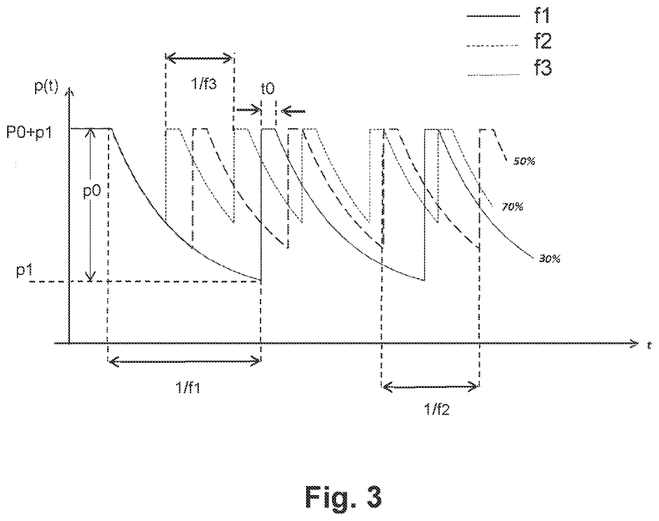

The resulting temporal pressure curve p(t) of the pressurized gas flowing into the mixing channel 17 is shown schematically in FIG. 3 for three different frequencies f1, f2 and f3. As can be seen from FIG. 3, the temporal pressure curve p(t) has periodically repeating and plateau-shaped flattened pressure peaks (p0), whereby each pressure peak (p0) up to the temporally following pressure peak has an exponentially decreasing pressure curve due to the damping effect of the damping element (15, 14), which can be described by the relation p(t)=p0·e^{-t/τ}, whereby the time constant τ depends on the volume of the expansion chamber 15 and the flow cross-section of the nozzle 14. The (maximum) amplitude of the (plateau-shaped flattened) pressure peaks (p0) depends on the constant pressure of the pressurized gas flow, which is set in the first part 3a of the conveying means 3 and kept at a predetermined constant level.

Each pressure peak has a constant, maximum pressure level (p0) over a predetermined time span t0, whereby the time span t0 is determined by the opening times (i.e. the pulse duration of the pressure pulses) of the switching valve 5 controlled by the control apparatus 9. In order to avoid influencing the subsequent exponential drop in pressure, the time span t0 should be chosen as short as possible.

Depending on the selected frequency f and the degree of damping of the damping element formed by the expansion chamber 15 and the nozzle 14, different mean pressure values of the pressurized gas flow averaged over time result, as shown in the diagram in FIG. 3 for the different frequencies f1, f2 and f3. In the diagram of FIG. 3, the time-averaged mean pressure values are indicated as a percentage of the maximum pressure for the frequencies f1, f2 and f3 respectively, whereby the maximum pressure (=100%) corresponds to the constant pressure of the pressurized gas flow which is provided by the pressure reducer 21 and flows into the second part 3b of the conveying medium.

As can be seen in FIG. 3, the gas stream flowing out of the expansion chamber 15 through the nozzle 14 has a pressure curve p(t) over time with a constant pressure offset (p1). The temporal pressure curve p(t) of the gas flow is therefore composed of the constant pressure offset p1 and the damped pressure peaks p0(t): p(t)=p1+p0(t). The constant pressure offset p1 is selected in such a way that the pressure p(t) of the pressurized gas flow is at all times higher than the pressure of the steam flow introduced via the ring channel 16 into the mixing channel 17.

In the event of a pressure drop in the expansion chamber 15, the non-return valve 20 prevents steam from the steam line 6 or liquid F from the container 10 from entering the switching valve 5. In the simplest case, the nozzle 14 can have a fixed flow cross-section. However, it can also be provided that the flow cross-section of the nozzle 14 can be controlled, for which purpose the nozzle 14 can be designed, for example, as a controllable throttle valve.

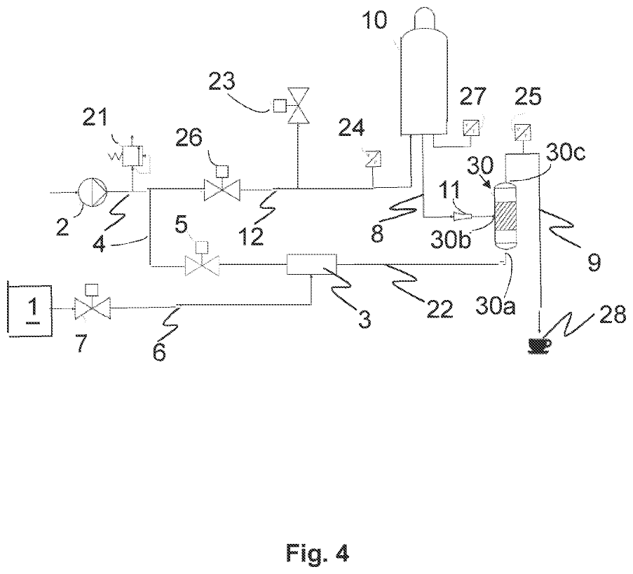

FIG. 4 shows a second embodiment of an apparatus according to the invention for heating and/or foaming a liquid. With this apparatus, a liquid, such as milk, can be simultaneously heated and foamed in a mixing device.

The apparatus shown in FIG. 4 comprises a container 10 for holding the liquid to be heated and foamed, a steam line 6 connected to a steam generator 1, a compressed gas line 4 connected to a source of compressed gas 2, and a mixing device 30 in communication with the steam line 6, the compressed gas line 4 and the container 10. The source of compressed gas 2 may be, for example, a compressor which draws in and compresses ambient air. The steam generator 1 may contain a hot water boiler which heats water to temperatures above boiling point. A steam valve 7 is arranged in the steam line 6 for opening and closing the steam line 6.

The substantially cylindrical mixing device 30 comprises a first inlet 30a arranged at the lower end of the mixing device 30 and a second inlet 30b arranged laterally approximately in the middle of the mixing device 30. Furthermore, the mixing device 30 has an output 30c at its upper end, to which an output line 9 is connected. The embodiment of an apparatus according to the invention shown in FIG. 4 further comprises a conveying means 3 for generating a steam/pressure mixture. The conveying means 3 is designed as shown in FIG. 2 and is connected to the compressed gas line 4 and to the steam line 6. Furthermore, an outlet of the conveying means 3 is connected to the first inlet 30a of the mixing device 30 via a discharge line 22. The design and function of the conveying means 3 for generating a steam/pressure mixture corresponds to the embodiment of the invention according to FIGS. 1 to 3.

The second inlet 30b of the mixing device 30 is connected to the container 10 via a liquid line 8. Preferably, one end of the liquid line 8 opens into an opening in the bottom of the container 10, as shown in FIG. 4. A nozzle 11 is arranged at the other end of the liquid line 8, which opens into the second inlet 30b of the mixing device 30. The nozzle 11 is shown outside the mixing device 30 in FIG. 4 for the sake of clarity, but is actually located in the area of the second inlet 30b of the mixing device 30.

The mixing device 30 is preferably designed as the heater unit described in WO 2017/063936 A1. WO 2017/063 936A1 is taken into reference to in this respect. The mixing device 30 comprises in particular a linear channel extending along the cylindrical mixing device 30 and standing vertically, which extends from the first inlet 30a of the mixing device 30 to its outlet 30c, wherein the steam/compressed gas mixture flows upwards in the linear channel against the force of gravity.

A branch line 12 branches off from the compressed gas line 4, and runs from the compressed gas source 2 to an inlet of the conveying means 3, which is connected to the container 10. It is also expedient that the branch line 12 opens into the bottom of the container 10, as can be seen in FIG. 4.

A switchable shut-off valve 26 is arranged in the branch line 12, with which the branch line 12 can be opened and closed. Furthermore, a pressure release valve 23 and a pressure sensor 24 are provided in the branch line 12.

An adjustable pressure reducer 21 is arranged in the compressed gas line 4. The pressure reducer 21 can be an adjustable pressure relief valve, for example. Furthermore, a switching valve 5 is arranged in the compressed gas line 4 upstream of the conveying means 3, which is expediently designed as a solenoid valve and is separated from the conveying means 3 in the embodiment example of FIG. 4.

To detect the temperature of the liquid in the container 10, the latter is coupled to a temperature sensor 27. To detect the temperature of the heated and foamed liquid, another temperature sensor 25 is coupled to the outlet pipe 9.

For heating and simultaneous foaming of the liquid, the compressed gas source 2 generates a pressurized gas, in particular compressed air, at a constant pressure. The pressure of the pressurized gas provided by the pressurized gas source 2 is regulated to a desired value by the pressure reducer 21 and introduced into the pressurized gas line 4. The switching valve 5 arranged in the compressed gas line 4 or integrated in the conveying means 3 is preferably opened and closed periodically so that periodic pressure pulses of the compressed gas are supplied to the expansion chamber 15 of the conveying means 3. At the same time, hot steam provided by the steam generator 1 is supplied to the conveying means 3 via the steam line 6 when the steam valve 7 is open. The pressure pulses of the compressed gas and the hot steam are mixed together in the conveying means 3 to produce a steam/pressure mixture, as explained above with reference to FIG. 2. The pulsed steam/pressure gas mixture formed in this way in the mixing channel 17 of the conveying means 3 is discharged through the discharge line 22 and directed to the first inlet 30a of the mixing device 30.

At the same time, the mixing device 30 is supplied with (cold) liquid from the container 10 via the second inlet 30b and the liquid line 8 connected thereto. In order to provide a supply pressure which is sufficient to transfer the liquid from the container 10 through the liquid line 8 and through the nozzle 11 into the mixing device 30, pressurized gas is introduced into the container 10 via the branch line 12 when the shut-off valve 26 is open and the pressure release valve 23 is closed. This creates an overpressure in the container 10, which conveys the liquid via the liquid line 8 and through the nozzle 11 into the second inlet 30b of the mixing device 30.

The steam/compressed gas mixture introduced at the first inlet 30a and the liquid introduced at the second inlet 30b are mixed in the mixing device 30, whereby the liquid is heated by the hot steam of the steam/compressed gas mixture and simultaneously foamed by the (damped) pressure pulses of the compressed gas. The heated liquid foam is discharged via the outlet line 9 and can be introduced into a collecting container 28, for example a cup, which is arranged at the mouth of the outlet line 9 and is open at the top.

The controllable valves, i.e. the steam valve 7, the switching valve 5, the shut-off valve 22 and the pressure release valve 23, as well as the adjustable pressure reducer 21 and the output of the steam generator 1 are controlled by a central control device. The valves and the pressure reducer 21 are controlled as a function of the pressure in the branch line 12 detected by the pressure sensor 24. The measurement signal from the temperature sensor 27 is used to monitor the temperature of the heated and foamed liquid. If the temperature detected by the temperature sensor 27 deviates from a set target temperature, the temperature of the heated and foamed liquid can be readjusted by either adjusting the pressure in the branch line 21 detected by the pressure sensor 24 (via the pressure reducer 21) and thus the amount of cold liquid supplied per unit of time and/or by adjusting the steam pressure provided by the steam generator 1 and thus the heating power used to heat the liquid by the control device.

1. An apparatus for heating and foaming a liquid, in particular a beverage, comprising:
a steam line connected to a steam generator;
a compressed gas line connected to a compressed gas source;
a conveying means connected to the steam line (4) and the compressed gas line for generating and transferring a steam/gas mixture into the liquid; and
a controllable switching valve,
wherein hot steam is fed to the conveying means via the steam line,
wherein a compressed gas flow under a predetermined constant pressure is fed to the conveying means via the compressed gas line,
wherein pressure pulses (p) are generated from the compressed gas flow by means of the switching valve, and
wherein the conveying means comprises an expansion chamber configured to control the introduced pressure pulses (p) and a nozzle arranged at a downstream end of the expansion chamber.

2. The apparatus according to claim 1, wherein the compressed gas source comprises a compressor, and
wherein the steam generator comprises a water heater.

3. The apparatus according to claim 1 wherein the switching valve comprises at least one of a solenoid valve or a pulse-width-modulated controlled solenoid valve.

4. The apparatus according to claim 1, wherein the switching valve is located upstream of the expansion chamber.

5. The apparatus according to claim 1, wherein the switching valve is controllable with a predetermined frequency (f) and generates pressure pulses (p) from the compressed gas flow by periodically opening and closing at the predetermined frequency (f) and directs the mixture into the expansion chamber.

6. The apparatus according to claim 5, wherein the predetermined frequency (f) of the pressure pulses is in the range of between about 0.1 to about 200 Hz or between 1 about and about 50 Hz.

7. The apparatus according to claim 1, wherein the introduced pressure pulses (p), characterized by one or more of a pulse frequency (f), a pulse duration (t0), and an amplitude (p0), as generated by the switching valve, is adjustable.

8. The apparatus according to claim 1, wherein the conveying means further comprises a non-return valve between the switching valve and the expansion chamber.

9. The apparatus according to claim 1, wherein a steam valve is arranged in the steam line.

10. The apparatus according to claim 9, wherein a control device is coupled to one or more of the steam generator, the steam valve, and the switching valve.

11. The apparatus according to claim 9, wherein the conveying means comprises an annular channel arranged coaxially with the cylindrically formed expansion chamber and in fluid communication with the steam line.

12. The apparatus of claim 11, wherein the annular channel is in fluid communication at an upstream end with the steam line and at a downstream end with a mixing channel.

13. The apparatus according to claim 12, wherein the downstream end of the mixing channel is connected to a discharge line.

14. The apparatus according to claim 12, wherein the nozzle opens into the mixing channel at an upstream end of the mixing channel.

15. The apparatus according to claim 1, wherein one or more or the expansion chamber and the nozzle are made of a thermally conductive material or stainless steel.

16. The apparatus according to claim 11, wherein one or more of the expansion chamber, the nozzle, the annular channel, and the mixing channel is arranged in a reactor block made at least partly of plastic or of PEEK.

17. The apparatus according to claim 16, wherein the expansion chamber is hollow, cylindrical, and extends along an axial direction in the reactor block.

18. The apparatus according to claim 17, wherein a diameter of the hollow-cylindrical expansion chamber is larger than a cross-section of the compressed gas line.

19. The apparatus according to claim 1, wherein a How cross-sect ion of the nozzle (14) is smaller than a diameter of the expansion chamber by at least a factor of 2.

20. The apparatus according to claim 5, wherein the pressure pulses (p) generated by periodically opening and closing the switching valve expand in the expansion chamber and are thereby damped.

21. The apparatus according to claim 1, wherein at least one of the expansion chamber and the nozzle act as a damping member for the pressure pulses (p) introduced into the expansion chamber.

22. The apparatus according to claim 1, wherein the steam/gas mixture flowing out of the expansion chamber through the nozzle has a pressure characteristic p(t) over time with damped, periodically repeating pressure peaks (p0).

23. The apparatus according to claim 1, wherein the steam/gas mixture flowing out of the expansion chamber through the nozzle has a pressure characteristic p(t) over time with periodically repeating and plateau-shaped flattened pressure peaks (p0), each pressure peak (p0) having an exponentially decreasing pressure characteristic up to the pressure peak following in time.

24. The apparatus according to claim 1, wherein the steam/gas mixture flowing out of the expansion chamber through the nozzle has a pressure characteristic p(t) over time with a constant pressure offset (p1).

25. The apparatus according to claim 1, further comprising at least one of an adjustable pressure reducer or an adjustable pressure relief valve located in at least one of the compressed gas line for in the conveying means.

26. The apparatus according to claim 25, wherein the pressure reducer is arranged in the conveying means upstream of the switching valve.

27. The apparatus according to claim 1, further comprising a container for holding the liquid; and
a mixing device in communication with one or more of the steam line, the compressed gas line, and the container, wherein the liquid and the pulses of the steam/compressed gas mixture generated by the conveying means are supplied to the mixing device and mixed in the mixing device to facilitate hot foaming of the liquid.

28. The apparatus according to claim 27, wherein the container is connected to the compressed gas line via a branch line.

29. The apparatus according to claim 27, wherein the liquid stored in the container is conveyed into the mixing device by overpressure provided by the compressed gas source.

30. The apparatus according to claim 27, wherein the mixing device comprises a first inlet for supplying the pulses of the steam/compressed gas mixture generated by the conveying means, a second inlet for supplying the liquid, and an outlet for discharging the heated and foamed liquid.

31. The apparatus according to claim 27, wherein the mixing device is in communication with the container via a liquid line.

32. The apparatus according to claim 30, wherein at least one of the liquid supplied to the container via the second inlet and the steam/compressed gas mixture supplied to the container via the first inlet flows upwards in the mixing device against the force of gravity.

33. The apparatus according to claim 30, wherein a nozzle is arranged in the region of the second inlet of the mixing device, with which nozzle the liquid is sprayed into the mixing device.

34. The apparatus according to claim 30, wherein the mixing device comprises a linear channel communicating with the first input.

35. The apparatus according to claim 34, wherein the mixing means comprises an annular channel communicating with the second inlet and arranged concentrically around the linear channel.

36. A method for foaming a liquid, in particular a beverage, with pulses of a steam/compressed gas mixture, wherein, in order to generate pulses of the steam/compressed gas mixture,
hot steam is supplied to a conveying means via a steam line and a compressed gas flow under a predetermined constant pressure is supplied via a compressed gas line, and
pressure pulses (p) are generated from the compressed gas flow by means of a switching valve, wherein the pressure pulses (p) of the compressed gas flow in the conveying means are damped by the interaction of an expansion chamber and a nozzle arranged at a downstream end of the expansion chamber.

37. The method according to claim 36, wherein the liquid is stored in a mixing vessel and the steam/compressed gas mixture is introduced into the liquid via an immersion tube.

38. The method according to claim 36, wherein the liquid is stored in a container and is led fed from the container to a mixing device in which the liquid is mixed with the steam/pressure gas mixture.

39. The method according to claim 38, wherein the liquid stored in the container is conveyed into the mixing device by overpressure provided by the compressed gas source.
